(19) United States
(12) Patent Application Publication
(10) Pub. No.: US 2008/0107884 A1
(43) Pub. Date: May 8, 2008

(54) Polyimide composite flexible board and its preparation

(75) Inventors: Kuen Yuan Hwang, Hsinchu (TW); An Pang Tu, Hsinchu (TW); Sheng Yen Wu, Hsinchu (TW); Te Yu Lin, Hsinchu (TW)

Correspondence Address: BIRCH STEWART KOLASCH & BIRCH, PO BOX 747, FALLS CHURCH, VA, 22040-0747, US

(73) Assignee: CHANG CHUN PLASTICS CO., LTD.

(21) Appl. No.: 11/709,680

(22) Filed: Feb. 23, 2007

(30) Foreign Application Priority Data
Nov. 3, 2006 (TW) 095140737

(51) Int. Cl. B32B 27/32

(52) U.S. Cl. 428/220; 427/388.1; 428/339; 428/458

(57) ABSTRACT

The present invention relates to a polyimide composite flexible board and a process for preparing the same. The process comprises sequentially applying polyamic acids individually having a coefficient of thermal expansion (CTE) after imidization of more than 20 ppm and less than 20 ppm on a metal foil, subsequently subjecting the polyamic acids to imidization into polyimide by heating, to produce a polyimide composite flexible board, which is used as a printed circuit flexible board.

According to the present invention, it can obtain a polyimide composite flexible board having an excellent mechanical property, high heat resistance, and excellent dimension stability, and no warp without using an adhering agent.

### FIELD OF THE INVENTION

The present invention relates to polyimide composite flexible board and a process preparing the same.

### BACKGROUND OF THE INVENTION

Aromatic polyimide film has been widely used in various technical fields because it exhibits excellent high-temperature resistance, outstanding chemical properties, high insulation, and high mechanical strength. For example, aromatic polyimide film is advantageously used in the form of a composite sheet of successive aromatic polyimide film/metal film to produce a flexible printed circuit (FPC), a carrier tape of tape automated bonding (TAB), and a lead-on-chip (LOC) structural tape. Especially, the flexible printed circuit board has been broadly applied to materials of laptops, consumer electronic products, and mobile communication equipments.

Heat resistant plastic film such as aromatic polyimide film has been extensively used to laminate with metal foils in the production of printed circuit board. Most known aromatic polyimide film laminated with the metal foils is generally produced by using a thermosetting adhesive to combine the aromatic polyimide film with the metal foils together. A two-side flexible circuit board is mainly produced by applying the thermosetting adhesive such as epoxy resin or acrylic-based resin to both sides of polyimide film, and then removing a solvent through an oven to make the adhesive become Stage-B which is an intermediate stage during the reaction of the thermosetting resin, and subsequently laminating the upper and lower sides of the polyimide film with copper foils or the metal foils through heating and pressing, and finally putting the polyimide-containing foil in a high temperature oven to conduct thermosetting to Stage-C which is a final stage during the reaction of the thermosetting resin.

Nevertheless, the thermosetting adhesive is commonly deficient in the heat resistance and can only keep its adhesion under the temperature not more than 200° C. Therefore, most known adhesive cannot be used to produce composite film that needs high temperature treatment, for example, a printed circuit flexible board that needs weld or needs to be used under high temperature. To achieve heat resistance and flame retardance as required, the thermosetting resin used is halogen-containing flame resistant and bromine-containing resin or halogen-free phosphorus-containing resin. However, the halogen-containing thermosetting resin can generate toxic dioxins during burning which seriously pollute environment. Furthermore, the flexible board laminated by the thermosetting resin adhesive has high coefficient of thermal expansion, poor heat resistance, and bad dimension stability.

To overcome the above disadvantages of the flexible board produced by the thermosetting adhesive, the present inventors apply various polyamic acids as polyimide precursors to a metal foil and then subject the polyamic acids to imidization by heating to obtain a halogen-free and phosphorus-free flexible board having high adhesion, high heat resistance, and excellent dimension stability. However, certain polyimide, after laminating with a metal foil and subjecting to a processing procedure at an elevated temperature, will result in wrap or bend of a printed board, due to different coefficient of thermal expansion (CTE) between the polyimide and the metal foil. It would adversely affect the sequential processing procedure.

The present inventors have conducted an investigation on the structure of polyimide and developed a polyimide having a CTE value which can match with the CTE of a metal foil, and thus completed the present invention.

### BRIEF DESCRIPTION OF THE INVENTION

The present invention relates to a polyimide composite flexible board, which is made by sequentially laminating a metal foil, a first polyimide film having a coefficient of thermal expansion (CTE) of more than 20 ppm, and a second polyimide film having a coefficient of thermal expansion (CTE) of less than 20 ppm.

The present invention also relates to a process for preparing a polyimide composite flexible board, which comprises sequentially applying a polyamic acid resin having a CTE value after imidization of more than 20 ppm and a polyamic acid resin having a CTE value after imidization of less than 20 ppm on a metal foil, then subjecting the polyamic acids to imidization, to obtain the polyimide composite flexible board.

According to the present invention, it can obtain a polyimide composite flexible board having an excellent mechanical property, high heat resistance, excellent dimension stability, and no wrap without using an adhering agent.

According to the present invention, it provides a process for preparing the polyimide composite flexible board, which comprises the following steps:
(a) applying the first polyamic acid resin having a CTE value after imidization of more than 20 ppm on a metal foil, which is subsequently in an oven heated at a temperature of 90 to 140° C. and then of 150 to 200° C. to remove a solvent;
(b) taking out the metal foil that is applied with the first polyamic acid and has removed the solvent, following by applying the second polyamic acid resin having a CTE value after imidization of less than 20 ppm on the first polyamic acid layer, which is subsequently in an oven heated at a temperature of 90 to 140° C. and then of 150 to 200° C. to remove a solvent;
(c) into a nitrogen gas oven putting the metal foil applied with polyamic acids, which is then sequentially heated at a temperature of 160 to 190° C., 190 to 240° C., 270 to 320° C. and 330 to 370° C. to subject the polyamic acids to imidization.

The polyimide composite flexible board of the present invention has CTE value in a range of from (CTE value of metal foil-8 ppm)˜(CTE value of metal foil+8 ppm).

The polyimide composite flexible board of the present invention can be further laminated with a metal foil at polyimide side or with another polyimide composite flexible board through the polyimide faces.

### BRIEF DESCRIPTIONS OF FIGURES

FIG. 1 is a flow chart illustrating a commercial production of two-side flexible printed circuit board pressed with metal foils.

FIG. 2 is a schematic view of application equipment used in the process of the present invention.

FIG. 3 is a schematic view of imidization equipment used in the process of the present invention.

FIG. 4 is a schematic view of pressing equipment used in the process of the present invention.

### DETAILED DESCRIPTION OF THE INVENTION

In the process for preparing the polyimide composite flexible board of the present invention, the polyamic acid resin is obtained by reacting diamine of the following formula (I),

H₂N—R₁—NH₂ (I)

[wherein R₁ is a covalent bond; phenylene (-Ph-); -Ph-X-Ph- wherein X represents a covalent bond, C₁₋₄ alkylene which may be substituted with a halogen(s), —O-Ph-O—, —O—, —CO—, —S—, —SO—, or —SO₂—; C₂₋₁₄ aliphatic hydrocarbon group; C₄₋₃₀ aliphatic cyclic hydrocarbon group; C₆₋₃₀ aromatic hydrocarbon group; or -Ph-O—R₂—O-Ph- wherein R₂ represents -Ph- or -Ph-X-Ph-, and X represents a covalent bond, C₁₋₄ alkylene which may be substituted with a halogen(s), —O-Ph-O—, —O—, —CO—, —S—, —SO—, or —SO₂—];
with dianhydride of the following formula (II),

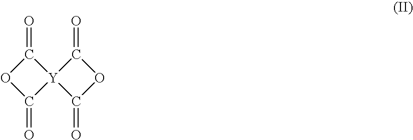

[wherein Y is a aliphatic group containing 2 to 12 carbon atoms; a cycloaliphatic group containing 4 to 8 carbon atoms; monocyclic or polycyclic C₆₋₁₄ aryl; >Ph-X-Ph< wherein X represents a covalent bond, C₁₋₄ alkylene which may be substituted with a halogen(s), —O-Ph-O—, —O—, —CO—, —S—, —SO—, or —SO₂—].

In the process for preparing the polyimide composite flexible board of the present invention, the first polyamic acid resin having a CTE value after imidization of more than 20 ppm is obtained by reacting a diamine monomer containing benzene ring and a dianhydride monomer containing benzene ring with other diamine monomer and other dianhydride monomer, under the conditions that the mole ratio of total diamine monomer/total dianhydride monomer ranges from 0.5 to 2.0, preferably from 0.75 to 1.25, and the mole ratio of diamine monomer containing benzene ring/other diamine monomer ranges from 60/40 to 20/80, and the mole ratio of dianhydride monomer containing benzene ring/other dianhydride monomer ranges from 40/60 to 20/80.

In the process of the present invention, the second polyamic acid resin having a CTE value after imidization of less than 20 ppm is obtained by reacting a diamine monomer containing benzene rings and a dianhydride monomer containing benzene rings with other diamine monomer and other dianhydride monomer, under the conditions that the mole ratio of total diamine monomer/total dianhydride monomer ranges from 0.5 to 2.0, preferably from 0.75 to 1.25, and the mole ratio of diamine monomer containing benzene ring/other diamine monomer ranges from 95/5 to 80/20; and the mole ratio of dianhydride monomer containing benzene ring/other dianhydride monomer ranges from 80/20 to 60/40.

Embodiments of the dianhydride for preparing the polyamic acid in the present invention is for instance, but not limited to, aromatic dianhydride such as pyromellitic dianhydride (PMDA), 4,4′-oxydiphthalic anhydride (ODPA), 3,3′,4,4′-biphenyltetracarboxylic dianhydride (BPDA), 3,3′,4,4′-benzophenonetetracarboxylic dianhydride (BTDA), ethylenetetracarboxylic dianhydride, butanetetracarboxylic dianhydride, cyclopentanetetracarboxylic dianhydride, 2,2′,3,3′-benzophenone-tetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)diphthalic dianhydride, 4,4′-(m-phenylenedioxy)diphthalic dianhydride, 2,3,6,7-naphthalene-tetracarboxylic dianhydride, 1,4,5,8-naphthalenetetracarboxylic dianhydride, 1,2,5,6-naphthalenetetracarboxylic dianhydride, 1,2,3,4-benzene-tetracarboxylic dianhydride, 3,4,9,10-perylenetetracarboxylic dianhydride, 2,3,6,7-anthracenetetracarboxylic dianhydride, 1,2,7,8-phenanthrene-tetracarboxylic dianhydride, etc. The foregoing dianhydrides can be used alone or in combination of two or more. Among these, pyromellitic dianhydride (PMDA), 4,4′-oxydiphthalic anhydride (ODPA), 3,3′,4,4′-biphenyltetracarboxylic dianhydride (BPDA), and 3,3′,4,4′-benzophenonetetracarboxylic dianhydride (BTDA) are preferable.

Embodiments of the diamine for preparing the polyamic acid in the present invention is for instance, but not limited to, aromatic diamine such as p-phenylene diamine (PDA), 4,4-oxydianiline (ODA), 1,3-bis(4-aminophenoxy)benzene (TPE-R), 1,3-bis(3-aminophenoxy)benzene (APB), 2,2-bis[4-(4-aminophenoxy)phenyl]propane (BAPP), bis[4-(4-aminophenoxy)phenyl]sulfone (BAPS), 4,4′-bis(4-aminophenoxy)-3,3′-dihydroxybiphenyl (BAPB), bis[4-(3-aminophenoxy)-phenyl]methane, 1,1-bis[4-(3-aminophenoxy)phenyl]ethane, 1,2-bis[4-(3-aminophenoxy)phenyl]ethane, 2,2-bis[4-(3-aminophenoxy)phenyl]-propane, 2,2′-bis[4-(3-aminophenoxy)phenyl]butane, 2,2-bis[4-(3-aminophenoxy)phenyl]-1,1,1,3,3,3-hexafluoropropane, 4,4′-bis(3-aminophenoxy)-biphenyl, bis[4-(3-aminophenoxy)phenyl]ketone, bis[4-(3-aminophenoxy)phenyl]sulfide, bis[4-(3-aminophenoxy)phenyl]sulfoxide, bis[4-(3-aminophenoxy)phenyl]sulfone, bis[4-(3-aminophenoxy)phenyl]-ether, etc. The foregoing diamines can be used alone or in combination of two or more. Among these, p-phenylene diamine (PDA), 4,4′-oxydianiline (ODA), 1,3-bis(4-aminophenoxy)benzene (TPE-R), 1,3-bis(3-aminophenoxy)benzene (APB), 2,2-bis[4-(4-aminophenoxy)phenyl]-propane (BAPP), bis[4-(4-aminophenoxy)phenyl]sulfone (BAPS), and 4,4′-bis(4-aminophenoxy)-3,3′-dihydroxybiphenyl (BAPB) are preferable.

The dianhydrides can react with the diamines in aprotic polar solvents. The aprotic polar solvents are not particularly limited as long as they do not react with reactants and products. Embodiments of the aprotic polar solvents are for instance N,N-dimethylacetamide (DMAc), N-methylpyrrolidone (NMP), N,N-dimethylformamide (DMF), tetrahydrofuran (ThF), dioxane, chloroform (CHCl₃), dichloromethane, etc. Among these, N-methylpyrrolidone (NMP) and N,N-dimethylacetamide (DMAc) are preferable.

The reaction of the dianhydrides and the diamines can be generally conducted in the range of from room temperature to 90° C., preferably from 30 to 75° C. Additionally, the mole ratio of aromatic diamines to aromatic dianhydrides ranges between 0.5 and 2.0, preferably between 0.75 and 1.25. When two or more dianhydrides and diamines are individually used to prepare the polyamic acids, their kinds are not particularly limited but depend on the final use of the polyimides as required.

Preferably, for the first polyamic acid having a CTE value after imidization of more than 20 ppm, the used diamines containing a benzene ring at least include p-phenylene diamine (PDA) and 4,4′-oxydianiline (ODA), the used dianhydrides containing a benzene ring at least include pyromellitic dianhydride (PMDA), 3,3′,4,4′-biphenyltetracarboxylic dianhydride (BPDA) and 3,3′,4,4′-benzophenonetetracarboxylic dianhydride (BTDA) under the conditions that the mole ratio of diamine monomer containing a benzene ring/other diamine monomer ranges from 60/40 to 20/80, and the mole ratio of dianhydride monomer containing a benzene ring/other dianhydride monomer ranges from 40/60 to 20/80.

Preferably, for the second polyamic acid having a CTE value after imidization of less than 20 ppm, the used diamines containing a benzene ring are selected from at least one compound selected from the group consisting of p-phenylene diamine (PDA) and 4,4-oxydianiline (ODA), and the used dianhydrides containing a benzene ring are selected from at least one compound selected from the group consisting of pyromellitic dianhydride (PMDA), 3,3′,4,4′-biphenyltetracarboxylic dianhydride (BPDA), under the conditions that the mole ratio of diamine monomer containing a benzene ring/other diamine monomer ranges from 95/5 to 80/20, the mole ratio of dianhydride monomer containing a benzene ring/other dianhydride monomer ranges from 80/20 to 60/40.

According to the polyimide composite flexible board and its preparation of the present invention, the thickness of the metal foil such as copper foil is not particularly limited but depends on the final use of the obtained composite flexible board. However, the thickness of the metal foil usually ranges from 12 μm to 70 μm. Also, the thicknesses of the first polyimide film and the second polyimide film individually satisfy the following conditions.

$$3 / 100 ≦ \frac{thickness of said first polyimide film}{total thickness of two layer of polyimide } ≦ 35 / 100$$

$$30 / 100 ≦ \frac{thickness of said second polyimide film}{total thickness of two layer of polyimide } ≦ 94 / 100.$$

The polyimide composite flexible board according to the present invention, by using polyimide films each having different CTE value and through their containing effect by each other to allow the CTE value of the polyimide composite flexible board falling in a range of from (CTE value of metal foil-8 ppm)˜(CTE value of metal foil+8 ppm), its dimension stability can be further improved and problems of wrap or bending would not occur.

The present invention will be further illustrated by reference to the following synthesis examples and working examples. However, these synthesis examples and working examples are not intended to limit the scope of the present invention but only describe the preferred embodiments of the present invention.

### EXAMPLES

### Synthesis Examples

(a) Synthesis of Polyamic Acid (PAA) 1-1 (PAA Resin Having a CTE Value after Imidization of More than 20 ppm)

Into a four-neck bottle reactor equipped with a stirrer and a nitrogen gas conduit under the flow rate of nitrogen gas of 20 cc/min, 5.4 g (0.05 mole) of p-phenylene diamine (PDA) was placed and dissolved in N-methylpyrrolidone (NMW). After 15 minutes, 10 g (0.05 mole) 4,4′-oxydianiline (ODA) was fed to dissolve and meantime maintained at a temperature of 15° C. 8.82 g (0.03 mole) of 3,3′,4,4′-biphenyltetracarboxylic dianhydride (BPDA) and 15 g of NMP were fed in a first flask equipped with a stir bar and then stirred to dissolve. Subsequently, the mixture in the first flask was added to the above reactor that the nitrogen gas was continuously charged and stirred to carry out the reaction for one hour. 16.1 g (0.05 mole) of 3,3′,4,4′-benzophenonetetracarboxylic dianhydride (BTDA) and 30 g of NMP were fed in the second flask and then stirred to dissolve. Subsequently, the mixture in the second flask was added to the above reactor that the nitrogen gas was continuously charged and stirred to carry out the reaction for one hour. 4.36 g (0.02 mole) of pyromellitic dianhydride (PMDA) and 10 g of NMP were fed in the third flask and then stirred to dissolve. Subsequently, the mixture in the third flask was added to the above reactor that the nitrogen gas was continuously charged and stirred to carry out the reaction for one hour. Afterward, the reaction was carried out at a temperature of 15° C. for further four hours to obtain the Polyamic Acid (PAA) 1-1.

0.5 g of the obtained PAA 1-1 dissolved in 100 ml of NMP, and it was measured the intrinsic viscosity (IV) at a temperature of 25° C. as 0.85 dl/g. Then PAA 1-1 resin was formed into a film of a thickness of 12.5 μm and subjected the film to imidization, then measured its CTE value by using TMA (Thermal Mechanical Analysis)(Model Q400, manufactured by Du-Pont TA) under the conditions of: increasing temperature from room temperature to 400° C. at a rate of 10° C./min, force: 0.5 N, taking a temperature range of from 100 to 200° C. Its CTE value was found as 35 ppm.

According to the ingredients and their amount listed in Table 1, Polyamic Acids 1-2 and 1-3 were synthesized by the analogous procedures and measured the intrinsic viscosity (IV) and the CTE value after imidization and shown in Table 1 as well.

TABLE 1

| | PAA 1-1 | PAA 1-2 | PAA 1-3 |
|---|---|---|---|
| BPDA (mole) | 0.03 | 0.02 | 0.03 |
| BTDA (mole) | 0.05 | 0.06 | 0.05 |
| PMDA (mole) | 0.02 | 0.02 | 0.02 |
| PDA (mole) | 0.05 | 0.05 | 0.06 |
| ODA (mole) | 0.05 | 0.05 | 0.04 |
| Intrinsic Viscosity | 0.85 | 0.93 | 0.97 |
| (IV) (dl/g) | | | |
| CTE value (ppm) | 35 | 40 | 30 |

(b) Synthesis of PAA 2-1 (PAA Resin Having a CTE Value after Imidization of Less than 20 ppm)

Into a four-neck bottle reactor equipped with a stirrer and a nitrogen gas conduit under the flow rate of nitrogen gas of 20 cc/min, 9.72 g (0.09 mole) of p-phenylene diamine (PDA) was placed and dissolved in N-methylpyrrolidone (NMP). After 15 minutes, 2.00 g (0.01 mole) of 4,4′-oxydianiline (ODA) was fed to dissolve while maintained at a temperature of 15° C. 5.88 g (0.02 mole) of 3,3′,4,4′-biphenyltetracarboxylic dianhydride (BPDA) and 15 g of NMP were fed in a first flask equipped with a stir bar and then stirred to dissolve. Subsequently, the mixture in the first flask was added to the above reactor that the nitrogen gas was continuously charged and stirred to carry out the reaction for one hour. 17.44 g (0.08 mole) of pyromellitic dianhydride (PMDA) and 30 g of NMP were fed in the second flask and then stirred to dissolve. Subsequently, the mixture in the second flask was added to the above reactor that the nitrogen gas was continuously charged and stirred to carry out the reaction for one hour. Afterward, the reaction was carried out at a temperature of 15° C. for further four hours to obtain the PAA 2-1.

0.5 g of the obtained PAA 2-1 dissolved in 100 ml of NMP, and it was measured the intrinsic viscosity (IV) at a temperature of 25° C. as 0.65 dl/g. Its CTE value after imidization was measured by TMA instrument as like for PAA 1-1.

According to the ingredients and their amount listed in Table 2, PAA 2-2 and 2-3 were synthesized by the analogous procedures and measured the intrinsic viscosity (IV) and the CTE value after imidization and shown in Table 2 as well.

TABLE 2

| | PAA 2-1 | PAA 2-2 | PAA 2-3 |
|---|---|---|---|
| BPDA(mole) | 0.02 | 0.02 | 0.04 |
| PMDA(mole) | 0.08 | 0.08 | 0.06 |
| PDA(mole) | 0.09 | 0.08 | 0.09 |
| ODA(mole) | 0.01 | 0.02 | 0.01 |
| Intrinsic Viscosity | 0.65 | 0.73 | 0.67 |
| (IV) (dl/g) | | | |
| CTE (ppm) | 10 | 13 | 15 |

### Working Examples 1 to 14 and Comparative Examples 1 to 3

According to ingredients listed in Table 3 and Table 4, the polyamic acid resin 1 obtained from the above synthesis examples was evenly applied on a copper foil having a thickness of 18 μm by a wire rod, and the thickness of the applied polyamic acid resin 1 was 3 μm. Into an oven, the copper foil was heated at a temperature of 120° C. for 3 minutes and 180° C. for 5 minutes to remove solvent. The dried copper foil coated with the polyamic acid 1 was taken out on which the polyamic acid resin 2 was then applied with the thickness of 17 μm. Subsequently, into an oven, the copper foil was heated at a temperature of 120° C. for 3 minutes and 180° C. for 7 minutes to remove solvent. The obtained copper foil was put into a nitrogen gas oven at a temperature of 180° C. for 1 hour, 220° C. for 1 hour, 300° C. for 0.6 hour, and 350° C. for 0.5 hour to subject the polyamic acids to imidization reaction produce the polyimide flexible printed circuit board having a structure of copper foil/polyimide 1 (CTE value more than 20 ppm)/polyimide 2 (CTE value less than 20 ppm).

Similar to the measurement of CTE value for PAA 1-1, the resultant polyimide flexible printed circuit board was measured its CTE value, the results are shown in Tables 3 and 4.

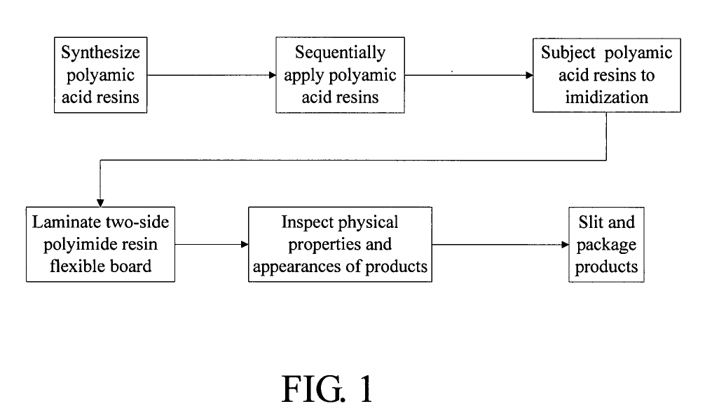

The polyimide composite flexible board of the present invention can be further laminated with a metal foil at polyimide side or with another polyimide composite flexible board through the polyimide faces to obtain two metal sides composite flexible board. Generally, the two metal-side composite flexible board could be produced as a procedure shown in FIG. 1. Various polyamic acid resins were synthesized, sequentially applied on a metal foil, and subjected to imidization into polyimide. Afterwards, the polyimide resin-containing flexible board was laminated with a metal foil such as a copper foil by pressing. The flexible board was subsequently inspected physical properties and appearances and then slit and packaged.

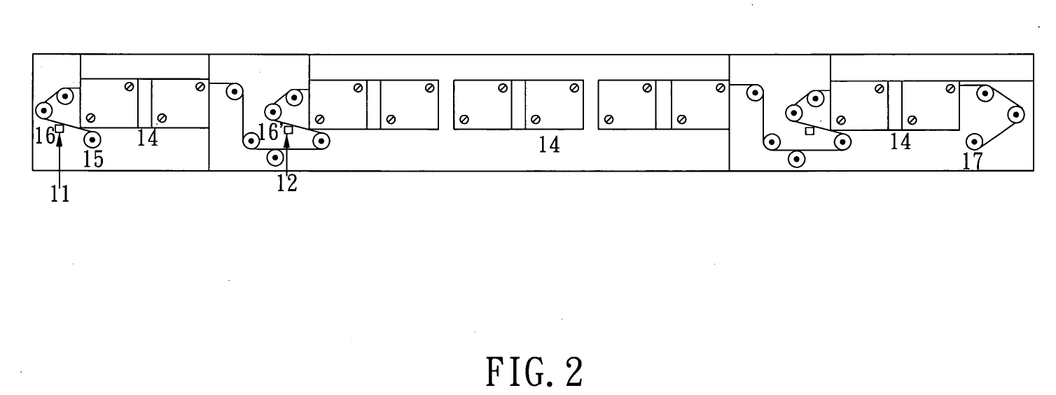

The foregoing flexible board could be produced by using equipments shown in FIG. 2 to FIG. 4. Firstly, the polyamic acid resins were applied by utilizing the application equipment shown in FIG. 2. The metal (copper) foil was delivered to the application equipment by a feeding roller 15; applied with polyamic acid resin 1 at location 11 by an applicator head 16 and passed through an oven 14 to conduct the first stage of heating and removing a solvent; then applied with polyamic acid resin 2 at location 12 by an applicator head 16′ and passed through an oven 14′ to conduct the second stage of heating and removing a solvent; and collected on the other side by a collect roller 17. The metal (copper) foil roll applied with two layers of different polyamic acid resins was obtained.

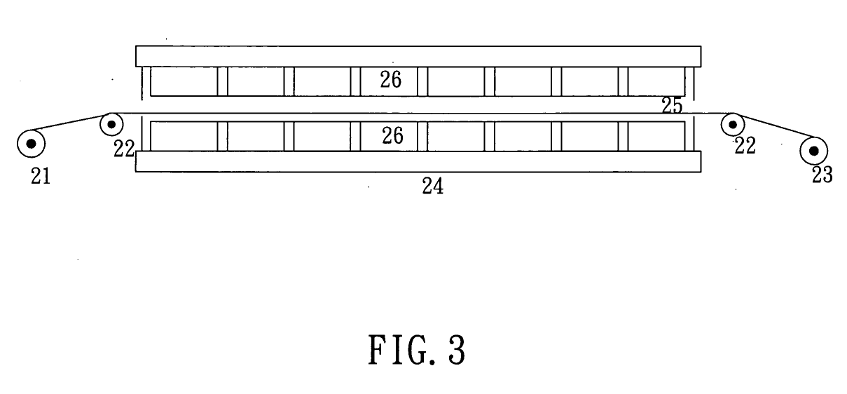

Subsequently, the imidization equipment shown in FIG. 3 was utilized. The foregoing metal foil roll was put on a feeding roller 21; introduced and passed through an oven 24 and a nitrogen gas oven 25 by guide rollers 22, 22 that were individually installed at the inlet and the outlet of the oven 24; subjected to imidization by a heating apparatus 26; and collected on the other side by a collect roller 23. The metal foil roll having two layers of different polyimides was obtained.

The resultant polyimide composite flexible board was measured its peeling strength according to the method of IPC-TM650 2.2.9, measured its CTE value by using TMA instrument as mentioned above, and measured its dimension stability according to the method of IPC-TM650 2.2.4. The results are also shown in Tables 3 and 4.

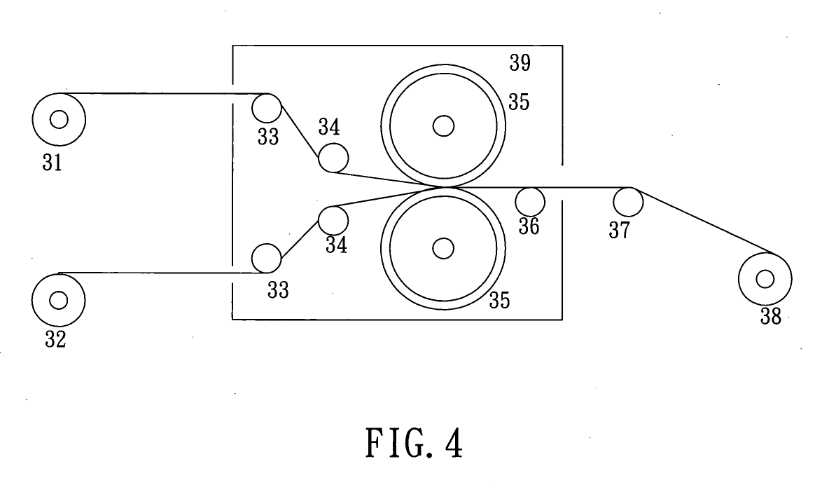

The polyimide composite flexible board of the present invention can be further laminated with a metal foil at polyimide side or with another polyimide composite flexible board through the polyimide faces by using the pressing equipment shown in FIG. 4. The above obtained metal (copper) foil roll having two layers of different polyimides was put on a feeding roller 32, and meanwhile another metal (copper) foil roll having two layers of different polyimides or another metal (copper) foil roll only was put on another feeding roller 31. Both foil rolls were introduced and passed through a high temperature pressing roller 35 by individual guide rollers 33 and 34; pressed to produce a metal (copper) foil roll having two-side metal; and collected at a collect roller 38 through guide rollers 36 and 37. The guide rollers 33, 34 and 36 and the high temperature pressing roller 35 were placed into a nitrogen gas oven 39.

TABLE 3

| | Working Example Number | | | | | | | | | | |
|---|---|---|---|---|---|---|---|---|---|---|---|
| | 1 | 2 | 3 | 4 | 5 | 6 | 7 | 8 | 9 | 10 | 11 |
| Metal Foil | A | A | A | A | A | A | A | A | A | A | A |
| (Copper Foil) | | | | | | | | | | | |
| 1^{st} Layer of | PAA | PAA 1-1 | PAA 1-1 | PAA 1-1 | PAA 1-1 | PAA 1-2 | PAA 1-2 | PAA 1-2 | PAA 1-3 | PAA 1-3 | PAA 1-3 |
| Polyimide (Kind) | 1-1 | | | | | | | | | | |
| 1^{st} Layer of | 3 μm | 3 μm | 3 μm | 3 μm | 3 μm | 3 μm | 3 μm | 3 μm | 3 μm | 3 μm | 3 μm |
| Polyimide | | | | | | | | | | | |
| (Thickness) | | | | | | | | | | | |
| CTE value of 1^{st} | 35 | 35 | 35 | 35 | 35 | 40 | 40 | 40 | 30 | 30 | 30 |
| Polyimide (ppm) | | | | | | | | | | | |
| 2^{nd} Layer of | PAA | PAA 2-1 | PAA 2-1 | PAA 2-2 | PAA 2-3 | PAA 2-1 | PAA 2-2 | PAA 2-3 | PAA 2-1 | PAA 2-2 | PAA 2-3 |
| Polyimide (Kind) | 2-1 | | | | | | | | | | |
| 2^{nd} Layer of | 22 μm | 17 μm | 9 μm | 22 μm | 22 μm | 22 μm | 22 μm | 22 μm | 22 μm | 22 μm | 22 μm |
| Polyimide | | | | | | | | | | | |
| (Thickness) | | | | | | | | | | | |
| CTE value of 2^{nd} | 10 | 10 | 10 | 13 | 15 | 10 | 13 | 15 | 10 | 13 | 15 |
| Polyimide (ppm) | | | | | | | | | | | |
| Peel Strength | 1.3 | 1.4 | 1.3 | 1.2 | 1.3 | 1.4 | 1.5 | 1.4 | 1.6 | 1.2 | 1.1 |
| (kgf/cm) | | | | | | | | | | | |
| CTE value of whole | 17 | 20 | 22 | 20 | 21 | 18 | 20 | 22 | 16 | 18 | 22 |
| flexible board (ppm) | | | | | | | | | | | |
| Board warp (mm) | plane | Plane | plane | plane | plane | plane | plane | plane | plane | plane | plane |
| Dimension stability | −0.03 | −0.05 | −0.07 | −0.05 | −0.05 | −0.03 | −0.07 | −0.03 | −0.05 | −0.05 | −0.04 |
| (%, MD) | | | | | | | | | | | |
| Dimension stability | −0.05 | −0.04 | −0.05 | −0.03 | −0.06 | −0.04 | −0.07 | −0.06 | −0.03 | −0.05 | −0.02 |
| (%, TD) | | | | | | | | | | | |

Copper Foil A: Electrolytic copper foil ⅓ OZ ED manufactured by Chang Chun Plastic Co., Ltd., Taiwan, R.O.C.

TABLE 4

| | Working Example Number | | | | | Comparative Example Number | | |
|---|---|---|---|---|---|---|---|---|
| | 12 | 13 | 14 | 15 | 16 | 1 | 2 | 3 |
| Metal Foil (Copper Foil) | A | A | A | A | A | A | A | A |
| 1^{st} Layer of Polyimide (Kind) | PAA 1-3 | PAA 1-3 | PAA 1-3 | PAA 1-1 | PAA 1-1 | PAA 1-1 | PAA 2-1 | PAA 2-1 |
| 1^{st} Layer of Polyimide | 2 μm | 5 μm | 7 μm | 2 μm | 5 μm | 25 μm | 25 μm | 3 μm |
| (Thickness) | | | | | | | | |
| CTE value of 1^{st} Polyimide | 30 | 30 | 30 | 35 | 35 | 35 | 10 | 10 |
| (ppm) | | | | | | | | |
| 2^{nd} Layer of Polyimide (Kind) | PAA 2-1 | PAA 2-1 | PAA 2-1 | PAA 2-1 | PAA 2-1 | | | PAA 1-1 |
| 2^{nd} Layer of Polyimide | 10 μm | 10 μm | 10 μm | 6 μm | 10 μm | | | 11 μm |
| (Thickness) | | | | | | | | |
| CTE value of 2^{nd} Polyimide | 10 | 10 | 10 | 10 | 10 | | | 35 |
| (ppm) | | | | | | | | |
| Peel Strength (kgf/cm) | 1.3 | 1.2 | 1.3 | 1.1 | 1.4 | 1.5 | 0.7 | 0.6 |
| CTE value of whole flexible | 13 | 19 | 21 | | | | | |
| board (ppm) | | | | | | | | |
| Board warp (mm) | Plane | plane | plane | plane | plane | 15 | plane | plane |
| Dimension stability (%, MD) | −0.03 | −0.07 | −0.08 | −0.06 | −0.03 | −1.6 | −0.01 | −0.12 |
| Dimension stability (%, TD) | −0.05 | −0.07 | −0.06 | −0.05 | −0.05 | −1.4 | −0.009 | −0.14 |

Copper Foil A: Electrolytic copper foil ⅓ OZ ED manufactured by Chang Chun Plastic Co., Ltd., Taiwan, R.O.C.

According to the present invention, by using the polyamic acid resins individually having different CTE value after imidization, the resultant polyimide composite flexible board has a CTE value falling in a range of from (CTE value of metal foil-8 ppm)˜(CTE value of metal foil+8 ppm). Accordingly, it possesses an excellent mechanical property, high heat resistance, excellent dimension stability, and no wrap without using an adhering agent.

What is claimed is:

1. A polyimide composite flexible board, which is made by sequentially laminating a metal foil, a first polyimide film having a coefficient of thermal expansion (CTE) of more than 20 ppm, and a second polyimide film having a coefficient of thermal expansion (CTE) of less than 20 ppm.

2. The polyimide composite flexible board according to claim 1, wherein said first polyimide having a coefficient of thermal expansion (CTE) value of more than 20 ppm is obtained by reacting a diamine monomer containing benzene ring and a dianhydride monomer containing benzene ring with other diamine monomer and other dianhydride monomer, under the conditions that the mole ratio of total diamine monomer/total dianhydride monomer ranges from 0.5 to 2.0, and the mole ratio of diamine monomer containing benzene ring/other diamine monomer ranges from 60/40 to 20/80, and the mole ratio of dianhydride monomer containing benzene ring/other dianhydride monomer ranges from 40/60 to 20/80; and
said second polyimide having a CTE value of less than 20 ppm is obtained by reacting a diamine monomer containing benzene rings and a dianhydride monomer containing benzene rings with other diamine monomer and other dianhydride monomer, under the conditions that the mole ratio of total diamine monomer/total dianhydride monomer ranges from 0.5 to 2.0, and the mole ratio of diamine monomer containing benzene ring/other diamine monomer ranges from 95/5 to 80/20; and the mole ratio of dianhydride monomer containing benzene ring/other dianhydride monomer ranges from 80/20 to 60/40.

3. The polyimide composite flexible board according to claim 2, wherein said diamine is represented by formula (I),
H₂N—R₁—NH₂ (I)
[wherein R₁ is a covalent bond; phenylene (-Ph-); -Ph-X-Ph- (wherein X represents a covalent bond; C₁₋₄ alkylene which may be substituted with a halogen(s); —O-Ph-O—; —O—; —CO—; —S—; —SO—; or —SO₂—); C₂₋₁₄ aliphatic hydrocarbon group; C₄₋₃₀ aliphatic cyclic hydrocarbon group; C₆₋₃₀ aromatic hydrocarbon group; or -Ph-O—R₂—O-Ph- wherein R₂ represents -Ph- or -Ph-X-Ph- (wherein X represents a covalent bond; C₁₋₄ alkylene which may be substituted with a halogen(s); —O-Ph-O—; —O—; —CO—; —S—; —SO—; or —SO₂—)];
and the dianhydride is presented by formula (II), 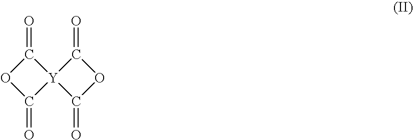
[wherein Y is a aliphatic group containing 2 to 12 carbon atoms; a cycloaliphatic group containing 4 to 8 carbon atoms; monocyclic or polycyclic C₆₋₁₄ aryl; >Ph-X-Ph< (wherein X represents a covalent bond; C₁₋₄ alkylene which may be substituted with a halogen(s); —O-Ph-O—; —O—; —CO—; —S—; —SO—; or —SO₂—)].

4. The polyimide composite flexible board according to claim 1, wherein the thickness of said metal foil ranges from 12 μm to 70 μm.

5. The polyimide composite flexible board according to claim 4, wherein said metal foil is a copper foil.

6. The polyimide composite flexible board according to claim 1, wherein the polyimide composite flexible board is further laminated with a metal foil through the polyimide side.

7. The polyimide composite flexible board according to claim 1, wherein the polyimide composite flexible board is further laminated with another polyimide composite flexible board under the polyimide sides facing each other, in which the another polyimide composite flexible board is the same or different from the polyimide composite flexible board

8. The polyimide composite flexible board according to claim 1, wherein the thicknesses of said first polyimide film and said second polyimide film individually satisfy the following conditions,
$$3 / 100 ≦ \frac{thickness of said first polyimide film}{total thickness of two layer of polyimide } ≦ 35 / 100$$
$$30 / 100 ≦ \frac{thickness of said second polyimide film}{total thickness of two layer of polyimide } ≦ 94 / 100.$$
.

9. A process for preparing a polyimide composite flexible board, which comprises the following steps:
(a) applying the first polyamic acid resin having a CTE value after imidization of more than 20 ppm on a metal foil, which is subsequently in an oven heated at a temperature of 90 to 140° C. and then of 150 to 200° C. to remove a solvent;
(b) taking out the metal foil that is applied with the first polyamic acid and has removed the solvent, following by applying the second polyamic acid resin having a CTE value after imidization of less than 20 ppm on the first polyamic acid layer, which is subsequently in an oven heated at a temperature of 90 to 140° C. and then of 150 to 200° C. to remove a solvent;
(c) into a nitrogen gas oven putting the metal foil applied with polyamic acids, which is then sequentially heated at a temperature of 160 to 190° C., 190 to 240° C., 270 to 320° C. and 330 to 370° C. to subject the polyamic acids to imidization.

10. The process according claim 9, wherein said first polyamic acid having a CTE value after imidization of more than 20 ppm is obtained by reacting a diamine monomer containing benzene ring and a dianhydride monomer containing benzene ring with other diamine monomer and other dianhydride monomer, under the conditions that the mole ratio of total diamine monomer/total dianhydride monomer ranges from 0.5 to 2.0, and the mole ratio of diamine monomer containing benzene ring/other diamine monomer ranges from 60/40 to 20/80, and the mole ratio of dianhydride monomer containing benzene ring/other dianhydride monomer ranges from 40/60 to 20/80; and
said second polyamic acid having a CTE value after imidization of less than 20 ppm is obtained by reacting a diamine monomer containing benzene rings and a dianhydride monomer containing benzene rings with other diamine monomer and other dianhydride monomer, under the conditions that the mole ratio of total diamine monomer/total dianhydride monomer ranges from 0.5 to 2.0, and the mole ratio of diamine monomer containing benzene ring/other diamine monomer ranges from 95/5 to 80/20; and the mole ratio of dianhydride monomer containing benzene ring/other dianhydride monomer ranges from 80/20 to 60/40.

11. The process according claims 10, wherein said diamine is represented by formula (I),
H₂N—R₁—NH₂ (I)
[wherein R₁ is a covalent bond; phenylene (-Ph-); -Ph-X-Ph- (wherein X represents a covalent bond; C₁₋₄ alkylene which may be substituted with a halogen(s); —O-Ph-O—; —O—; —CO—; —S—; —SO—; or —SO₂—); C₂₋₁₄ aliphatic hydrocarbon group; C₄₋₃₀ aliphatic cyclic hydrocarbon group; C₆₋₃₀ aromatic hydrocarbon group; or -Ph-O—R₂—O-Ph- wherein R₂ represents -Ph- or -Ph-X-Ph- (wherein X represents a covalent bond; C₁₋₄ alkylene which may be substituted with a halogen(s); —O-Ph-O—; —O—; —CO—; —S—; —SO—; or —SO₂—)];
and said dianhydride is presented by formula (II), 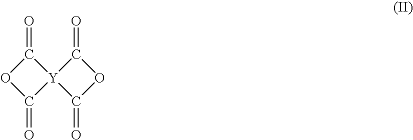
[wherein Y is a aliphatic group containing 2 to 12 carbon atoms; a cycloaliphatic group containing 4 to 8 carbon atoms; monocyclic or polycyclic C₆₋₁₄ aryl; >Ph-X-Ph<(wherein X represents a covalent bond; C₁₋₄ alkylene which may be substituted with a halogen(s); —O-Ph-O—; —O—; —CO—; —S—; —SO—; or —SO₂—)].

12. The process according claim 9, wherein the thickness of said metal foil ranges from 12 μm to 70 μm.

13. The process according claim 12, wherein said metal foil is a copper foil.

14. The process according claim 9, wherein after said first polyamic acid resin and said second polyamic acid resin are subjected to imidization, the thicknesses of the first polyimide film and the second polyimide film individually satisfy the following conditions,
$$3 / 100 ≦ \frac{thickness of said first polyimide film}{total thickness of two layer of polyimide } ≦ 35 / 100$$
$$30 / 100 ≦ \frac{thickness of said second polyimide film}{total thickness of two layer of polyimide } ≦ 94 / 100.$$
